(19) United States
(12) Patent Application Publication
(10) Pub. No.: US 2014/0007590 A1
(43) Pub. Date: Jan. 9, 2014

(54) Systems and Methods For Carbon Dioxide Capture In Low Emission Turbine Systems

(71) Applicants: Richard A. Huntington, Houston, TX (US); Franklin F. Mittricker, Jamul, CA (US); Omer Angus Sites, Spring, TX (US); Sulabh K. Dhanuka, Houston, TX (US); Dennis M. O'Dea, Somerset, NJ (US); Russell H. Oelfke, Houston, TX (US); Robert D. Denton, Bellaire, TX (US)

(72) Inventors: Richard A. Huntington, Houston, TX (US); Franklin F. Mittricker, Jamul, CA (US); Omer Angus Sites, Spring, TX (US); Sulabh K. Dhanuka, Houston, TX (US); Dennis M. O'Dea, Somerset, NJ (US); Russell H. Oelfke, Houston, TX (US); Robert D. Denton, Bellaire, TX (US)

(21) Appl. No.: 14/005,174

(22) PCT Filed: Mar. 5, 2012
(86) PCT No.: PCT/US12/27776

§ 371 Date: Sep. 13, 2013

Related U.S. Application Data
(60) Provisional application No. 61/466,385, filed on Mar. 22, 2011.
(60) Provisional application No. 61/466,381, filed on Mar. 22, 2011.
(60) Provisional application No. 61/466,384, filed on Mar. 22, 2011.
(60) Provisional application No. 61/542,030, filed on Sep. 30, 2011.
(60) Provisional application No. 61/542,031, filed on Sep. 30, 2011.
(60) Provisional application No. 61/542,037, filed on Sep. 30, 2011.
(60) Provisional application No. 61/542,035, filed on Sep. 30, 2011.

(51) Int. Cl. F02C 3/00

(52) U.S. Cl. CPC F02C 3/00
USPC 60/801

(57) ABSTRACT

Systems, methods, and apparatus are provided for generating power in low emission turbine systems and capturing and recovering carbon dioxide from the exhaust. In one or more embodiments, the exhaust is cooled, compressed, and separated to yield a carbon dioxide-containing effluent stream and a nitrogen-containing product stream.

### CROSS REFERENCE TO RELATED APPLICATIONS

This application claims priority to U.S. Provisional Application 61/542,037 filed Sep. 30, 2011 entitled, SYSTEMS AND METHODS FOR CARBON DIOXIDE CAPTURE IN LOW EMISSION TURBINE SYSTEMS; U.S. Provisional Application 61/466,384 filed Mar. 22, 2011 entitled, LOW EMISSION TURBINE SYSTEMS HAVING A MAIN AIR COMPRESSOR OXIDANT CONTROL APPARATUS AND METHODS RELATED THERETO; U.S. Provisional Application 61/542,030 filed Sep. 30, 2011 entitled, LOW EMISSION TURBINE SYSTEMS INCORPORATING INLET COMPRESSOR OXIDANT CONTROL APPARATUS AND METHODS RELATED THERETO; U.S. Provisional Application 61/466,385 filed Mar. 22, 2011 entitled, METHODS FOR CONTROLLING STOICHIOMETRIC COMBUSTION ON A FIXED GEOMETRY GAS TURBINE SYSTEM AND APPARATUS AND SYSTEMS RELATED THERETO; U.S. Provisional Application 61/542,031 filed Sep. 30, 2011 entitled, SYSTEMS AND METHODS FOR CONTROLLING STOICHIOMETRIC COMBUSTION IN LOW EMISSION TURBINE SYSTEMS; U.S. Provisional Application 61/466,381 filed Mar. 22, 2011 entitled, METHODS OF VARYING LOW EMISSION TURBINE GAS RECYCLE CIRCUITS AND SYSTEMS AND APPARATUS RELATED THERETO; U.S. Provisional Application 61/542,035 filed Sep. 30, 2011 entitled, METHODS OF VARYING LOW EMISSION TURBINE GAS RECYCLE CIRCUITS AND SYSTEMS AND APPARATUS RELATED THERETO; all of which are hereby incorporated by reference in their entirety.

This application is related to U.S. Provisional Application 61/542,036 filed Sep. 30, 2011 entitled, SYSTEMS AND METHODS FOR CARBON DIOXIDE CAPTURE IN LOW EMISSION TURBINE SYSTEMS; U.S. Provisional Application 61/542,039 filed Sep. 30, 2011 entitled, SYSTEMS AND METHODS FOR CARBON DIOXIDE CAPTURE IN LOW EMISSION COMBINED TURBINE SYSTEMS; U.S. Provisional Application 61/542,041 filed Sep. 30, 2011 entitled, LOW EMISSION POWER GENERATION SYSTEMS AND METHODS INCORPORATING CARBON DIOXIDE SEPARATION; all of which are hereby incorporated by reference in their entirety.

### FIELD OF THE DISCLOSURE

Embodiments of the disclosure relate to low emission power generation. More particularly, embodiments of the disclosure relate to methods and apparatus for carbon dioxide capture for increased efficiency and reduced cost in low emission turbine systems.

### BACKGROUND OF THE DISCLOSURE

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Many oil producing countries are experiencing strong domestic growth in power demand and have an interest in enhanced oil recovery (EOR) to improve oil recovery from their reservoirs. Two common EOR techniques include nitrogen (N₂) injection for reservoir pressure maintenance and carbon dioxide (CO₂) injection for miscible flooding for EOR. There is also a global concern regarding green house gas (GHG) emissions. This concern combined with the implementation of cap-and-trade policies in many countries makes reducing CO₂ emissions a priority for those countries as well as for the companies that operate hydrocarbon production systems therein.

Some approaches to lower CO₂ emissions include fuel de-carbonization or post-combustion capture using solvents, such as amines. However, both of these solutions are expensive and reduce power generation efficiency, resulting in lower power production, increased fuel demand and increased cost of electricity to meet domestic power demand. In particular, the presence of oxygen, SO_{X}, and NO_{X} components makes the use of amine solvent absorption very problematic. Another approach is an oxyfuel gas turbine in a combined cycle (e.g., where exhaust heat from the gas turbine Brayton cycle is captured to make steam and produce additional power in a Rankine cycle). However, there are no commercially available gas turbines that can operate in such a cycle and the power required to produce high purity oxygen significantly reduces the overall efficiency of the process.

Moreover, with the growing concern about global climate change and the impact of carbon dioxide emissions, emphasis has been placed on minimizing carbon dioxide emissions from power plants. Gas turbine power plants are efficient and have a lower cost compared to nuclear or coal power generation technologies. Capturing carbon dioxide from the exhaust of a gas turbine power plant is very expensive, however, for the following reasons: (a) the concentration of carbon dioxide in the exhaust stack is low, (b) a large volume of gas needs to be treated, (c) the pressure of the exhaust stream is low, (d) a large amount of oxygen is present in the exhaust stream, (e) additional cooling of the flue gas is required before entering a CO₂ capture system, and (f) the flue gas is saturated with water after cooling, which increases the reboiler duty in a CO₂ capture system. All of these factors result in a high cost of carbon dioxide capture.

Accordingly, there is still a substantial need for a low emission, high efficiency power generation process with incorporated CO₂ capture and recovery at a reduced cost.

### SUMMARY OF THE DISCLOSURE

In the low emission power generation systems described herein, exhaust gases from low emission gas turbines, which are vented in a typical natural gas combined cycle (NGCC) plant, are instead separated and recovered. The apparatus, systems, and methods of the invention combine an open Brayton cycle that uses an oxidant and hydrocarbon fuel to generate power with a carbon dioxide separation process. The exhaust gases are cooled, compressed, and separated to capture CO₂ efficiently.

In the systems and methods of the present invention, exhaust gases exiting the combustion chamber of a low emission gas turbine are expanded in an expander and passed through a heat recovery unit (HRU), generating power and steam. The exhaust gases are then cooled, compressed, and separated in a CO₂ separation process to generate a CO₂ effluent stream and a product stream comprising oxygen and nitrogen. The CO₂ recovered may be injected into hydrocarbon reservoirs for enhanced oil recovery, sequestered, stored, sold, or vented. The product stream may be expanded to generate additional power before being vented, used for pressure maintenance in hydrocarbon reservoirs, or used elsewhere in the system. By cooling and compressing the exhaust stream, the separation equipment may be downsized and the effectiveness of the separation process may be improved.

### BRIEF DESCRIPTION OF THE DRAWINGS

The foregoing and other advantages of the present disclosure may become apparent upon reviewing the following detailed description and drawings of non-limiting examples of embodiments in which:

FIG. 1 depicts a low emission power generation system incorporating CO₂ separation.

FIG. 2 depicts a low emission power generation system incorporating CO₂ separation with supplemental heating of the exhaust and product streams using combustors.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

As used herein, the term “natural gas” refers to a multi-component gas obtained from a crude oil well (associated gas) and/or from a subterranean gas-bearing formation (non-associated gas). The composition and pressure of natural gas can vary significantly. A typical natural gas stream contains methane (CH₄) as a major component, i.e. greater than 50 mol % of the natural gas stream is methane. The natural gas stream can also contain ethane (C₂H₆), higher molecular weight hydrocarbons (e.g., C₃-C₂₀ hydrocarbons), one or more acid gases (e.g., carbon dioxide or hydrogen sulfide), or any combination thereof. The natural gas can also contain minor amounts of contaminants such as water, nitrogen, iron sulfide, wax, crude oil, or any combination thereof.

As used herein, the term “stoichiometric combustion” refers to a combustion reaction having a volume of reactants comprising a fuel and an oxidizer and a volume of products formed by combusting the reactants where the entire volume of the reactants is used to form the products. As used herein, the term “substantially stoichiometric” combustion refers to a combustion reaction having a molar ratio of combustion fuel to oxygen ranging from about 0.9:1 to about 1.1:1, or more preferably from about 0.95:1 to about 1.05:1. Use of the term “stoichiometric” herein is meant to encompass both stoichiometric and substantially stoichiometric conditions unless otherwise indicated.

As used herein, the term “stream” refers to a volume of fluids, although use of the term stream typically means a moving volume of fluids (e.g., having a velocity or mass flow rate). The term “stream,” however, does not require a velocity, mass flow rate, or a particular type of conduit for enclosing the stream.

Embodiments of the presently disclosed systems and processes may be used to produce low emission electric power and CO₂ for enhanced oil recovery (EOR) or sequestration applications. According to embodiments disclosed herein, a mixture of compressed oxidant (typically air) and fuel is combusted and the exhaust gas is expanded to generate power. The exhaust gas is then cooled, compressed, and separated to capture CO₂ and generate a product stream comprising oxygen and nitrogen. In EOR applications, the recovered CO₂ is injected into or adjacent to producing oil wells, usually under supercritical conditions. The CO₂ acts as both a pressurizing agent and, when dissolved into the underground crude oil, significantly reduces the oil's viscosity enabling the oil to flow more rapidly through the earth to a removal well. The systems and processes herein also generate a product stream that may comprise oxygen and nitrogen in varying amounts. The product stream may be used to generate additional power, and may also be used for a variety of purposes, including for pressure maintenance applications. In pressure maintenance applications, an inert gas such as nitrogen is compressed and injected into a hydrocarbon reservoir to maintain the original pressure in the reservoir, thus allowing for enhanced recovery of hydrocarbons. The result of the systems disclosed herein is the production of power and the manufacturing or capture of additional CO₂ at a more economically efficient level.

In the systems and methods herein, one or more oxidants are compressed and combusted with one or more fuels in a combustion chamber. The oxidant may comprise any oxygen-containing fluid, such as ambient air, oxygen-enriched air, substantially pure oxygen, or combinations thereof. The one or more oxidants may be compressed in one or more compressors. Each compressor may comprise a single stage or multiple stages. In multiple stage compressors, interstage cooling may optionally be employed to allow for higher overall compression ratios and higher overall power output. The compressor may be of any type suitable for the process described herein. Such compressors include, but are not limited to, axial, centrifugal, reciprocating, or twin-screw compressors and combinations thereof. The fuel may comprise natural gas, associated gas, diesel, fuel oil, gasified coal, coke, naphtha, butane, propane, syngas, kerosene, aviation fuel, bio-fuel, oxygenated hydrocarbon feedstock, any other suitable hydrocarbon containing gases or liquids, hydrogen, or combinations thereof. Additionally, the fuel may comprise inert components including but not limited to N₂ or CO₂. In some embodiments, the fuel may be at least partially supplied by a hydrocarbon reservoir that is benefitting from enhanced oil recovery via injection of the CO₂ captured via the process described herein. The combustion conditions in the combustion chamber may be lean, stoichiometric or substantially stoichiometric, or rich. In one or more embodiments, the combustion conditions are stoichiometric or substantially stoichiometric.

In some embodiments, high pressure steam may be employed as a coolant in the combustion process. In such embodiments, the addition of steam would reduce power and size requirements in the system, but would require the addition of a water recycle loop. Additionally, in further embodiments, the compressed oxidant feed to the combustion chamber may comprise argon. For example, the oxidant may comprise from about 0.1 to about 5.0 vol % argon, or from about 1.0 to about 4.5 vol % argon, or from about 2.0 to about 4.0 vol % argon, or from about 2.5 to about 3.5 vol % argon, or about 3.0 vol % argon.

Combustion of the oxidant and fuel in the combustion chamber generates an exhaust stream, which is then expanded. The exhaust stream comprises products of combustion, and its composition will vary depending upon the composition of the fuel and the oxidant used. In one or more embodiments, the discharge exhaust stream from the combustion chamber may comprise vaporized water, CO₂, CO, oxygen, nitrogen, argon, nitrogen oxides (NO_{X}), sulfur oxides (SO_{X}), hydrogen sulfide (H₂S), or combinations thereof. The discharge exhaust stream may be expanded in one or more expanders. Each of the one or more expanders may comprise a single stage or multiple stages. The expander may be any type of expander suitable for the process described herein, including but not limited to axial or centrifugal expanders or combinations thereof. Expansion of the exhaust stream generates power, which may be used to drive one or more compressors or electric generators. In one or more embodiments of the invention, the expander is coupled to the oxidant compressor via a common shaft or other mechanical, electrical, or other power coupling, such that the oxidant compressor is at least partially driven by the expander. In other embodiments, the oxidant compressor may be mechanically coupled to an electric motor with or without a speed increasing or decreasing device such as a gear box. When taken together, the oxidant compressor, combustion chamber, and exhaust expander may be characterized as an open Brayton cycle.

After expansion, the gaseous exhaust stream may in some embodiments be cooled in a heat recovery unit (HRU). The HRU may be any apparatus or process designed to cool the expander effluent stream, such as for example one or more heat recovery steam generators (HRSG), process heat recovery units, non-aqueous vaporization units, or combinations thereof. The HRU may be configured to generate heat for use in other processes, such as for heating crude oil for a distillation unit, heating steam or a non-aqueous vapor for use in a Rankine cycle power generation system, or for combinations thereof. In one or more embodiments, the HRU is a HRSG. The HRSG may be configured to utilize the residual heat in the exhaust stream to generate steam. The steam generated by the HRSG may be used for a variety of purposes, such as to drive a steam turbine generator in a Rankine cycle or for water desalination. In one or more embodiments, the HRSG may comprise a duct burner or burners to allow for secondary firing of the exhaust gases. Such secondary firing not only allows for increased steam production, and therefore increased power generation, but also increases the CO₂ concentration in the exhaust stream by combusting at least part of the oxygen in the stream. The cost of capturing and recovering CO₂ from the exhaust stream is reduced as the CO₂ concentration in the exhaust stream increases.

In one or more embodiments of the present invention, the gaseous exhaust stream exiting the HRU may be sent to one or more cooling units configured to reduce the temperature of the exhaust stream. The cooling unit may be any type of apparatus suitable for lowering the temperature of the exhaust gases, such as for example a direct contact cooler (DCC), trim cooler, mechanical refrigeration unit, or combinations thereof. In some embodiments, the cooling unit is a DCC. The cooling unit can also be configured to remove a portion of condensed water from the exhaust stream via a water dropout stream. In some embodiments, the water dropout stream may be routed to the HRU to provide a water source for the generation of additional steam.

Once cooled via the HRU and/or the cooling unit, the gaseous exhaust stream may be sent to a compressor or blower configured to increase the pressure of the exhaust stream, thereby generating a compressed exhaust stream. In one or more embodiments, the pressure of the exhaust stream at the outlet of the exhaust compressor may be from about 150 to about 450 psia, or from about 200 to about 400 psia, or from about 250 to about 350 psia. Cooling and compressing the exhaust stream helps to address issues related to the large volume of gas that must be treated and the low pressure of the exhaust stream that ordinarily lead to a high cost of CO₂ capture, thus making CO₂ capture and recovery in the present systems more efficient and more cost effective.

After compression of the exhaust stream, in some embodiments it may be desirable to heat the compressed exhaust stream using an optional supplementary combustor or other heating device. In some embodiments, a combustor may be employed to heat the compressed exhaust stream to a temperature of from about 1100 to about 1700° F., or from about 1150 to about 1650° F., or from about 1200 to about 1600° F., or from about 1250 to about 1550° F., or form about 1300 to about 1500° F. It will be appreciated that the use of an additional combustor will require additional fuel, and the fuel supplied to the exhaust combustor may be the same as or different from the fuel supplied to the main combustion chamber as described previously. In some embodiments, the fuel may be a non-carbon fuel source, such as hydrogen. The oxidant required by the supplementary combustor may be supplied via a separate oxidant stream, or there may be sufficient oxidant in the compressed exhaust stream such that an additional supply of oxidant is unnecessary.

Whether or not the compressed exhaust stream is heated in a supplemental heater or other device, the compressed exhaust stream exiting the compressor or combustor may then be supplied to a heat exchanger configured to cool the compressed exhaust stream while supplying heat to another process stream. In some embodiments, the compressed exhaust stream may exchange heat with the product stream exiting the CO₂ separator, described in more detail below. In some cases, additional cooling of the compressed exhaust stream may be desired, in which case the exhaust stream exiting the heat exchanger may be directed to a supplemental cooling unit, such as for example a trim cooler.

In one or more embodiments, the compressed exhaust stream is then fed to one or more separators, in which CO₂ and other greenhouse gases are separated from the exhaust stream. The CO₂ separation process may be any suitable process designed to separate the pressurized exhaust gases and result in an effluent stream comprising CO₂ and a product stream comprising nitrogen and oxygen. Separating the components of the exhaust gas allows different components in the exhaust to be handled in different ways. Ideally, the separation process would segregate all of the greenhouse gases in the exhaust, such as CO₂, CO, NO_{X}, SO_{X}, etc. in the effluent stream, leaving the remainder of the exhaust components such as nitrogen, oxygen, and argon in the product stream. In practice, however, the separation process may not withdraw all of the greenhouse gases from the product stream, and some non-greenhouse gases may remain in the effluent stream. Any suitable separation process designed to achieve the desired result may be used. In one or more embodiments, the separation process is an oxygen-insensitive process. Examples of suitable separation processes include, but are not limited to, hot potassium carbonate (“hot pot”) separation processes, amine separation, molecular sieve separation, membrane separation, adsorptive kinetic separation, controlled freeze zone separation, and combinations thereof. In some embodiments, the CO₂ separator uses a hot pot separation process. In one or more embodiments of the invention, the separation process operates at elevated pressure (i.e., higher than ambient) and is configured to keep the product stream pressurized. Maintaining pressure on the process in this manner allows for smaller separation equipment, provides for improved separation effectiveness, and allows for increased energy extraction from the product stream. In some embodiments, the CO₂ separation process is selected and configured to maximize either the outlet pressure or the outlet temperature, or both, of the product stream.

The CO₂ effluent stream may be used for a variety of applications. For example, the effluent stream may be injected into a hydrocarbon reservoir for enhanced oil recovery (EOR) or may be directed to a reservoir for carbon sequestration or storage. The effluent stream may also be sold, vented, or flared. In one or more embodiments, at least a portion of the effluent stream may be recycled and mixed with the oxidant entering the main combustion chamber or added directly to the combustion chamber to act as a diluent to control or otherwise moderate the temperature of the combustion and flue gas entering the succeeding expander.

Optionally, in one or more embodiments, the product stream from the CO₂ separator, comprising primarily nitrogen and oxygen (and possibly comprising argon when air is used as an oxidant in the main or supplementary combustor), may be directed from the separator to the heat exchanger described above, where the product stream may be used to cool the compressed exhaust stream. In one or more embodiments, flow of the product stream and the compressed exhaust stream through the heat exchanger is countercurrent. Passing the product stream through the heat exchanger serves to further heat the product stream, allowing for additional power generation in the expander.

Additionally, the product stream may optionally be further heated using a supplementary combustor or other heating device. It will be appreciated that the use of an additional combustor will require additional fuel. If a carbon-containing fuel is used in the combustor, additional CO₂ will be generated that will be unrecoverable from the product stream. Therefore, in some embodiments, the fuel used in the product combustor may be a non-carbon fuel source, such as hydrogen. The oxidant required by the supplementary combustor may be supplied via a separate oxidant stream, or there may be sufficient oxidant in the product stream such that an additional supply of oxidant is unnecessary.

Upon exiting the separator, heat exchanger, or combustor, the product stream may be directed to an expander. In one or more embodiments, the expander may be configured to receive the product stream and output the same gases at approximately ambient pressure. As will be appreciated by those skilled in the art, the expander generates power, and the power generated may be used to drive one or more compressors or electric generators in any configuration, either within the described system or externally. Conveniently, in one or more embodiments, the product expander may at least partially drive the exhaust compressor via a common shaft or other mechanical, electrical, or other power coupling.

In one or more embodiments, the product stream may pass through one or more heat recovery units (HRUs), such as for example one or more heat recovery steam generators (HRSGs), after expansion. The one or more HRUs may be configured to utilize the residual heat in the stream to generate steam or other non-aqueous vapors. The steam or other vapors generated by the one or more HRUs may be used for a variety of purposes, such as to drive a turbine generator in a Rankine cycle or for water desalination. Further, if any residual heat remains in the product stream exiting the one or more HRUs, the system may further comprise one or more heat exchangers configured to transfer that heat to a non-steam working fluid. In such embodiments, the non-steam working fluid may optionally be used to drive an expander in a Rankine cycle.

The product stream may be used, wholly or in part, for a variety of applications. For example, the product stream may be injected into a hydrocarbon reservoir for pressure maintenance. The product stream may also be sold or vented. In one or more embodiments when pressure maintenance is not a viable option (or when only a portion of the product stream is required for pressure maintenance), the product stream may be cooled, by expansion or another method, and used to provide refrigeration in the systems described herein. For example, the cooled product stream may be used to provide refrigeration to reduce the suction temperature of one or more compressors within the system, or to chill water for use in one or more cooling units within the system.

In other embodiments when all or part of the product stream is not used for pressure maintenance, the product stream may instead be heated so that additional power may be generated for use elsewhere in the system or for sale. Some methods of heating the product stream are described above, such as cross-exchanging the exhaust stream and the product stream in a heat exchanger or using a supplementary combustor to supply additional heat to the product stream. Other possible methods include using a heating coil in the HRU to heat the product stream, using catalysis to combust any CO present in the product stream, or heating provided as a consequence of using the product stream for cooling (i.e., as the product stream provides cooling to other streams or apparatus, the stream itself is heated).

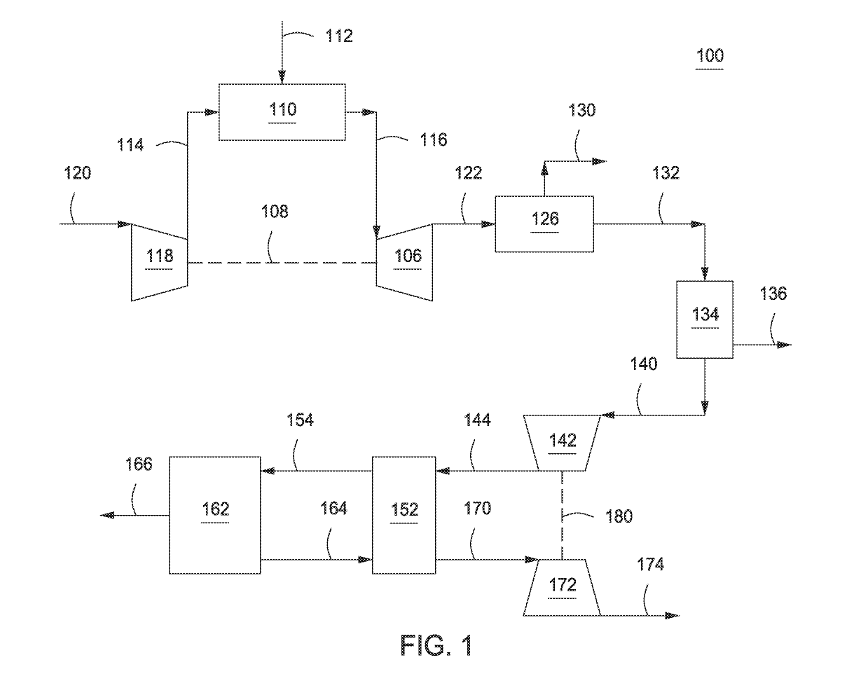

Referring now to the figures, FIG. 1 illustrates a power generation system 100 configured to provide separation and capture of CO₂ after combustion. In at least one embodiment, the power generation system 100 can have a compressor 118 coupled to an expander 106 through a common shaft 108 or other mechanical, electrical, or other power coupling, thereby allowing a portion of the mechanical energy generated by the expander 106 to drive the compressor 118. The expander 106 may generate power for other uses as well, such as to power another compressor, an electric generator, or the like. The compressor 118 and expander 106 may form the compressor and expander ends, respectively, of a standard gas turbine. In other embodiments, however, the compressor 118 and expander 106 can be individualized components in a system.

The system 100 can also include a main combustion chamber 110 configured to combust a fuel stream 112 mixed with a compressed oxidant 114. In one or more embodiments, the fuel stream 112 can include any suitable hydrocarbon gas or liquid, such as natural gas, methane, naphtha, butane, propane, syngas, diesel, kerosene, aviation fuel, coal derived fuel, bio-fuel, oxygenated hydrocarbon feedstock, or combinations thereof. The fuel stream 112 may also comprise hydrogen. The compressed oxidant 114 can be derived from the compressor 118 fluidly coupled to the main combustion chamber 110 and adapted to compress a feed oxidant 120. While the discussion herein assumes that the feed oxidant 120 is ambient air, the oxidant may comprise any suitable gas containing oxygen, such as air, oxygen-rich air, substantially pure oxygen, or combinations thereof. In one or more embodiments, the compressor 118, the combustion chamber 110, and the expander 106, taken together, can be characterized as an open Brayton cycle.

A discharge exhaust stream 116 is generated as a product of combustion of the fuel stream 112 and the compressed oxidant 114 and directed to the inlet of the expander 106. In at least one embodiment, the fuel stream 112 can be primarily natural gas, thereby generating a discharge 116 including volumetric portions of vaporized water, CO₂, CO, oxygen, nitrogen, argon, nitrogen oxides (NO_{X}), and sulfur oxides (SO_{X}). In some embodiments, a small portion of unburned fuel 112 or other compounds may also be present in the discharge 116 due to combustion equilibrium limitations. As the discharge stream 116 expands through the expander 106, it generates mechanical power to drive the compressor 118 or other facilities, and also produces a gaseous exhaust stream 122.

From the expander 106, the gaseous exhaust stream 122 is directed to a heat recovery steam generator (HRSG) 126 configured to use the residual heat in the gaseous exhaust stream 122 to generate steam 130 and gaseous exhaust stream 132. Note that although a HRSG is exemplified in FIG. 1, any suitable heat recovery unit (HRU) as described previously may be used. In some embodiments, the HRSG 126 incorporates a duct burner system (not shown) to provide secondary firing of the exhaust gas, thus increasing the concentration of CO₂ in the exhaust. The steam 130 generated by the HRSG 126 may have a variety of uses, such as for example to generate additional power by driving a steam turbine generator in a Rankine cycle or for water desalination.

The gaseous exhaust 132 can be sent to at least one cooling unit 134 configured to reduce the temperature of the gaseous exhaust 132 and generate a cooled exhaust stream 140. In one or more embodiments, the cooling unit 134 is considered herein to be a direct contact cooler (DCC), but may be any suitable cooling device such as a direct contact cooler, trim cooler, a mechanical refrigeration unit, or combinations thereof. The cooling unit 134 can also be configured to remove a portion of condensed water via a water dropout stream 136.

In one or more embodiments, the cooled exhaust stream 140 can be directed to an exhaust compressor 142 fluidly coupled to the cooling unit 134. The compressor 142 can be configured to increase the pressure of the cooled exhaust stream 140 before it is separated, thereby generating a compressed exhaust stream 144. From the compressor 142, the compressed exhaust stream 144 is directed to a heat exchanger 152, where it is cooled by exchanging heat with a cooling fluid, generating compressed exhaust stream 154. In one or more embodiments, the cooling fluid used in the heat exchanger 152 is the product stream 164 from the separator 162, discussed in more detail below.

The system 100 also includes a CO₂ separation system. In one or more embodiments, the compressed exhaust stream 154 is directed to a CO₂ separator 162. The CO₂ separator 162 may employ any of a variety of separation processes designed to separate the compressed exhaust stream 154 into an effluent stream 166 comprising CO₂ and a product stream 164 generally comprising nitrogen and oxygen and, in some cases, argon. For example, the separator 162 may be designed to separate the compressed exhaust stream 154 using a chemical separation process, such as hot potassium carbonate (“hot pot”) separation, amine separation, or separation using an adsorbent such as a molecular sieve. Other separation processes include physical separation using membranes, or processes such as adsorptive kinetic separation or controlled freeze zone separation. In some embodiments, combinations of the foregoing separation methods may be used. The effluent stream 166 may be used for a variety of downstream applications, such as injection into a hydrocarbon reservoir for enhanced oil recovery (EOR), carbon sequestration, storage, sale, or recycle to the combustion chamber 110 for use as a diluent to facilitate combustion of the compressed oxidant 114 and the first fuel 112 and increase the CO₂ concentration in the discharge exhaust stream 116. The effluent stream 166 may also be vented or flared. In one or more embodiments, the CO₂ separation process may be configured to maximize the temperature or the pressure of the product stream 164.

In one or more embodiments, the product stream 164 exiting the separator 162 may optionally be used for additional power generation. For example, product stream 164 may be heated in the heat exchanger 152 configured to transfer heat from the compressed exhaust stream 144 to the product stream 164. Upon exiting the heat exchanger 152, the product stream 170 may then be directed to an expander 172. The power generated by the product expander 172 may be used for a variety of purposes, such as to at least partially drive the exhaust compressor 142 or one or more additional compressors (not shown) or to drive an electric generator. In some embodiments, when either the product stream is injected into a reservoir for pressure maintenance, the expander 172 may be used to drive a pipeline or injection compressor.

In one or more embodiments, the expanded product stream 174 exiting the expander 172 may be directed to a heat recovery unit (not shown) for additional power generation. The product stream 174, like the effluent stream 166, may also be used for a variety of applications, including pressure maintenance, additional power generation, storage, or venting.

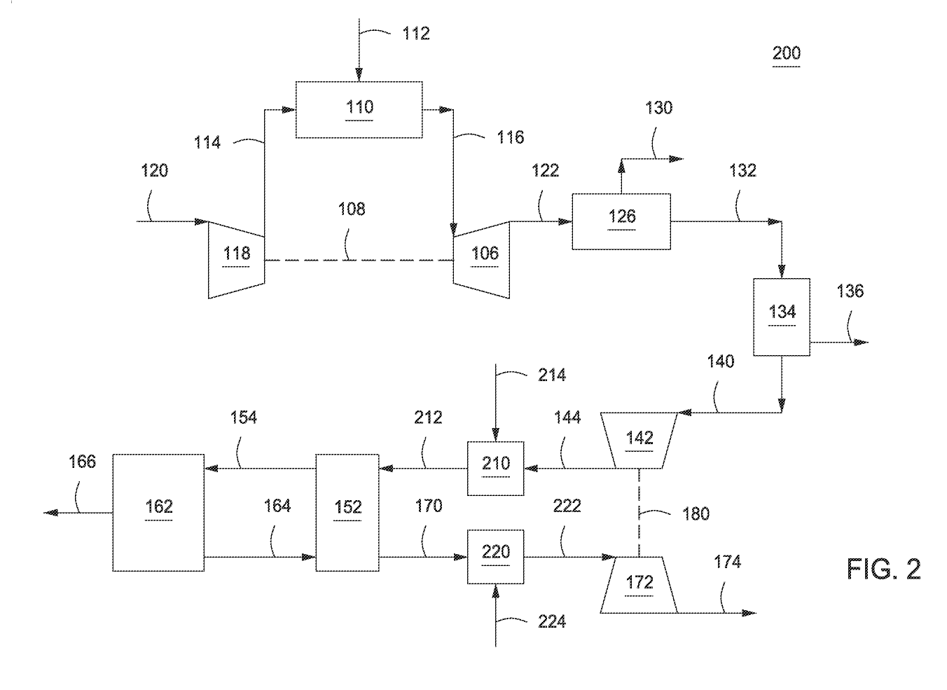

Referring now to FIG. 2, depicted is an alternative configuration of the power generation system 100 of FIG. 1, embodied and described as system 200. As such, FIG. 2 may be best understood with reference to FIG. 1. In system 200 of FIG. 2, supplementary heating of the compressed exhaust stream 144 and the product stream 170 is provided by combustors 210 and 220, respectively. In particular, compressed exhaust stream 144 is directed to a supplementary combustor 210 configured to combust a fuel stream 214 to add heat to the compressed exhaust stream 144, resulting in a compressed exhaust stream 212 having a higher temperature than that of stream 144. Fuel stream 214 may have the same composition as fuel stream 112, or may have a different composition. Similarly, product stream 170 is also directed to a supplementary combustor 220 configured to combust a fuel stream 224 to add heat to the product stream 170, resulting in a product stream 222 having a higher temperature than that of product stream 170. Fuel stream 224 may have the same composition as fuel stream 112 and/or fuel stream 214, or may have a different composition. In some embodiments, fuel stream 224 supplies a non-carbon fuel, such as one comprising hydrogen, to combustor 220. In one or more embodiments, a single control system may be used to monitor and control startup, operation, and shutdown of one, some, or all of the compressor 118, the combustion chamber 110, the expander 106, the HRSG 126, the cooling unit 134, the exhaust compressor 142, the product expander 172, and one or both of the supplementary combustors 210 and 220.

While the present disclosure may be susceptible to various modifications and alternative forms, the exemplary embodiments discussed above have been shown only by way of example. Any features or configurations of any embodiment described herein may be combined with any other embodiment or with multiple other embodiments (to the extent feasible) and all such combinations are intended to be within the scope of the present invention. Additionally, it should be understood that the disclosure is not intended to be limited to the particular embodiments disclosed herein. Indeed, the present disclosure includes all alternatives, modifications, and equivalents falling within the true spirit and scope of the appended claims.

What is claimed is:

1. A power generation system comprising:
a first compressor configured to receive and compress one or more oxidants;
a first combustion chamber configured to receive and combust the compressed oxidant and at least one first fuel to generate an exhaust stream;
a first expander configured to receive the exhaust stream from the first combustion chamber and generate a gaseous exhaust stream;
a heat recovery steam unit configured to receive and cool the gaseous exhaust stream and generate steam;
a first cooling unit configured to receive and further cool the gaseous exhaust stream;
a second compressor configured to receive and compress the gaseous exhaust stream; and
a separator configured to receive and separate the compressed exhaust stream into a CO₂ effluent stream and a product stream.

2. The system of claim 1, further comprising a heat exchanger configured to receive the compressed exhaust stream from the second compressor and cool the compressed exhaust stream before directing the compressed exhaust stream to the separator.

3. The system of claim 2, wherein the heat exchanger cools the compressed exhaust stream by exchanging heat with the product stream exiting the separator.

4. The system of claim 1, wherein the heat recovery unit is a heat recovery steam generator.

5. The system of claim 4, wherein the heat recovery steam generator comprises a duct burner.

6. The system of claim 2, further comprising a combustor configured to receive the compressed exhaust stream from the second compressor and heat the compressed exhaust stream before directing the compressed exhaust stream to the heat exchanger.

7. The system of claim 3, further comprising a second expander configured to receive the product stream from the heat exchanger and expand the product stream.

8. The system of claim 7, further comprising a combustor configured to receive the product stream from the heat exchanger and heat the product stream before directing the product stream to the second expander.

9. The system of claim 2, further comprising a second cooling unit configured to receive the compressed exhaust stream from the heat exchanger and further cool the compressed exhaust stream before directing the compressed exhaust stream to the separator.

10. The system of claim 1, wherein the separator uses a separation process selected from hot potassium carbonate separation, amine separation, molecular sieve separation, membrane separation, adsorptive kinetic separation, controlled freeze zone separation, or combinations thereof.

11. The system of claim 10, wherein the separator uses a hot potassium carbonate separation process.

12. The system of claim 1, wherein the product stream comprises oxygen and nitrogen.

13. The system of claim 1, wherein the CO₂ effluent stream is used for enhanced oil recovery in a hydrocarbon reservoir.

14. The system of claim 12, wherein the product stream is used for pressure maintenance in a hydrocarbon reservoir.

15. The system of claim 8, wherein the combustor uses a non-carbon fuel source.

16. The system of claim 15, wherein the fuel source comprises hydrogen.

17. A method for generating power comprising:
compressing one or more oxidants in a first compressor;
supplying the compressed oxidant and at least one first fuel to a first combustion chamber;
combusting the compressed oxidant and the at least one fuel in the first combustion chamber to generate an exhaust stream;
expanding the exhaust stream in a first expander to generate a gaseous exhaust stream;
cooling the gaseous exhaust stream in a heat recovery unit;
further cooling the gaseous exhaust stream in a cooling unit;
compressing the gaseous exhaust stream in a second compressor to generate a compressed exhaust stream; and
separating the compressed exhaust stream to generate an effluent stream comprising CO₂ and a product stream.

18. The method of claim 17, further comprising cooling the compressed exhaust stream in a heat exchanger before separating the compressed exhaust stream.

19. The method of claim 18, wherein the compressed exhaust stream is cooled by exchanging heat with the product stream.

20. The method of claim 17, wherein the heat recovery unit is a heat recovery steam generator.

21. The method of claim 20, wherein the heat recovery steam generator comprises a duct burner.

22. The method of claim 18, further comprising heating the compressed exhaust stream before directing the compressed exhaust stream to the heat exchanger.

23. The method of claim 22, wherein the compressed exhaust stream is heated in a combustor.

24. The method of claim 19, further comprising receiving the product stream from the heat exchanger and expanding the product stream in a second expander to generate power.

25. The method of claim 24, further comprising receiving the product stream from the heat exchanger and heating the product stream before expanding the product stream.

26. The method of claim 25, wherein the product stream is heated in a combustor.

27. The method of claim 18, further comprising receiving the compressed exhaust stream from the heat exchanger and further cooling the compressed exhaust stream before separating the compressed exhaust stream.

28. The method of claim 17, wherein the compressed exhaust stream is separated using a separation process selected from hot potassium carbonate separation, amine separation, molecular sieve separation, membrane separation, adsorptive kinetic separation, controlled freeze zone separation, or combinations thereof.

29. The method of claim 28, wherein the compressed exhaust stream is separated using a hot potassium carbonate separation process.

30. The method of claim 17, wherein the product stream comprises nitrogen and oxygen.

31. The method of claim 17, further comprising compressing the effluent stream and injecting the compressed effluent stream into a hydrocarbon reservoir for enhanced oil recovery.

32. The method of claim 24, further comprising supplying the expanded product stream to a hydrocarbon reservoir for pressure maintenance.

33. The method of claim 26, wherein the combustor uses a non-carbon fuel source.

34. The method of claim 33, wherein the fuel source comprises hydrogen.
